(19) United States
(12) Patent Application Publication
(10) Pub. No.: US 2024/0221100 A1
(43) Pub. Date: Jul. 4, 2024

(54) INFORMATION PROCESSING SYSTEM, INFORMATION PROCESSING METHOD AND PROGRAM

(71) Applicant: RAKUTEN GROUP, INC., Tokyo (JP)

(72) Inventors: Yu HIRATE, Setagaya-ku, Tokyo (JP); Manoj KONDAPAKA, Setagaya-ku, Tokyo (JP); Satyen ABROL, Setagaya-ku, Tokyo (JP)

(21) Appl. No.: 17/928,614

(22) PCT Filed: Dec. 23, 2021
(86) PCT No.: PCT/JP2021/047950

§ 371 Date: Nov. 29, 2022

(51) Int. Cl. G06Q 50/26

(52) U.S. Cl. CPC G06Q 50/265

(57) ABSTRACT

To grasp a situation of a household to which a user belongs in more detail, a household identification included in an information processing system acquires household information indicating a first household and a second household each including one or a plurality of users living together. Household relationship estimation unit included in the information processing system estimates a type of a relation between the first household and the second household based on an attribute of a user belonging to the first household and an attribute of a user belonging to the second household.

### TECHNICAL FIELD

The present invention relates to an information processing system, an information processing method, and a program.

### BACKGROUND ART

There is a technology for estimating whether each user has a spouse or a child based on information collected in some way.

In JP 2019-087212 A, it is disclosed that, in a financial transaction service, information relating to a family structure of a user is identified based on transaction information (see paragraphs 0048 and 0099).

In JP 2021-144451 A, there is disclosed an information processing device which identifies an income amount and an expenditure amount of a user, and determines details of liability indemnification based on the income amount and expenditure amount and the family structure of the user (see paragraph 0038).

### SUMMARY OF INVENTION

### Technical Problem

Until now, the presence or absence of a spouse or a child has been simply estimated as an attribute of a user, and a situation of a household to which the user belongs, for example, the details of the household to which the user belongs, has not been fully grasped.

The present invention has been made in view of the above-mentioned problem, and has an object to provide a technology for enabling a situation of a household to which a user belongs to be grasped in more detail.

### Solution to Problem

According to one embodiment of the present invention, there is provided an information processing system including: household identification means for acquiring household information indicating a first household and a second household each of which includes one or a plurality of users living together; and household relationship estimation means for estimating a type of a relation between the first household and the second household based on an attribute of a user belonging to the first household and an attribute of a user belonging to the second household.

According to one embodiment of the present invention, there is provided an information processing method including the steps of: acquiring a first household and a second household each of which includes one or a plurality of users living together; and estimating a type of a relation between the first household and the second household based on an attribute of a user belonging to the first household and an attribute of a user belonging to the second household.

According to one embodiment of the present invention, there is provided program for causing a computer to function as: household identification means for acquiring household information indicating a first household and a second household each of which includes one or a plurality of users living together; and household relationship estimation means for estimating a type of a relation between the first household and the second household based on an attribute of a user belonging to the first household and an attribute of a user belonging to the second household.

In one aspect of the present invention, the household identification means may be configured to acquire, based on a surname and a street address of each of a plurality of users stored in a user database, the first household and the second household each including one or a plurality of users living together from the plurality of users.

In one aspect of the present invention, the household relationship estimation means may be configured to estimate the type of the relation between the first household and the second household based on a plurality of parameters relating to a type of a relation between a first user included in the first household and a second user included in the second household.

In one aspect of the present invention, the plurality of parameters may include at least part of whether a surname is the same, a frequency of telephone contact, presence or absence of sending a gift relating to a specific day, a frequency of sending a gift to each other, an age difference, a friend in common, whether gender is the same, and similarity in street addresses.

In one aspect of the present invention, the household relationship estimation means may be configured to estimate the type of the relation between the first household and the second household depending on whether a type of a relation between a first user included in the first household and a second user included in the second household is any of at least part of parent-child, sibling, and neighbor.

### Advantageous Effects of Invention

According to the present invention, the situation of the household to which the user belongs can be grasped in more detail.

### BRIEF DESCRIPTION OF DRAWINGS

FIG. 1 is a diagram for illustrating an example of an overall configuration of an information processing system according to one embodiment of the present invention.

FIG. 2 is a functional block diagram for illustrating an example of functions of the information processing system according to the one embodiment of the present invention.

FIG. 3 is a diagram for schematically illustrating an example of common IP address data values.

FIG. 4 is a diagram for illustrating an example of graph data.

FIG. 5 is a diagram for schematically illustrating an example of common street address data values.

FIG. 6 is a diagram for illustrating an example of graph data.

FIG. 7 is a diagram for schematically illustrating an example of common credit card number data values.

FIG. 8 is a diagram for illustrating an example of graph data.

FIG. 9 is a diagram for illustrating an example of graph data.

FIG. 10 is a diagram for illustrating an example of clusters.

FIG. 11 is a diagram for illustrating an example of classification visualization.

FIG. 12 is a flow chart for illustrating an example of processing relating to creation of a social graph performed by the information processing system according to the one embodiment of the present invention.

FIG. 13 is a flow chart for illustrating an example of processing relating to identification of a family relationship of users in a household.

FIG. 14 is a diagram for illustrating an example of a machine learning model used by a presence/absence identification module.

FIG. 15 is a flow chart for illustrating an example of processing of a family identification module, an age estimation module, and a relationship recording module.

FIG. 16 is a diagram for illustrating relationships between users or the like in a household.

FIG. 17 is a table for showing an example of information stored in a household member table.

FIG. 18 is a table for showing an example of information stored in a user relationship table.

FIG. 19 is a table for showing an example of information stored in a member attribute table.

FIG. 20 is a flow chart for illustrating an example of processing relating to estimation of a relationship between households.

FIG. 21 is a diagram for illustrating an example of relationships between households.

FIG. 22 is a functional block diagram for illustrating an example of a functional configuration of a user relationship identification module.

### DESCRIPTION OF EMBODIMENTS

Description is given below in detail of one embodiment of the present invention with reference to the drawings. In this embodiment, a description is given of an information processing system 1 which identifies, based on information relating to users, a plurality of households each including one or a plurality of users, and estimates more detailed information relating to the identified households.

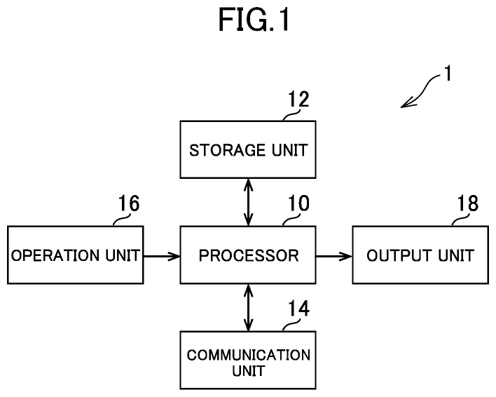

FIG. 1 is a diagram for illustrating an example of an overall configuration of the information processing system 1 according to the one embodiment of the present invention. As illustrated in FIG. 1, the information processing system 1 according to this embodiment is a computer, such as a server computer or a personal computer, and includes a processor 10, a storage unit 12, a communication unit 14, an operation unit 16, and an output unit 18. The information processing system 1 according to this embodiment may include a plurality of computers.

The processor 10 is, for example, a program-controlled device, such as a microprocessor, which operates in accordance with a program installed in the information processing system 1. The information processing system 1 may include a plurality of processors 10. The storage unit 12 is, for example, a storage element, such as a ROM or a RAM, a hard disk drive (HDD), or a solid-state drive (SSD) including a flash memory. The storage unit 12 stores, for example, a program to be executed by the processor 10. The communication unit 14 is a communication interface for wired communication or wireless communication, such as a network interface card, and exchanges data with another computer or terminal through a computer network, such as the Internet.

The operation unit 16 is an input device, and includes, for example, a pointing device, such as a touch panel or a mouse, or a keyboard. The operation unit 16 transmits operation content to the processor 10. The output unit 18 is an output device, for example, a display, such as a liquid crystal display unit or an organic EL display unit, or an audio output device, such as a speaker.

Programs and data to be described as being stored into the storage unit 12 may be supplied thereto from another computer via the network. Further, the hardware configuration of the information processing system 1 is not limited to the above-mentioned example, and various types of hardware can be applied thereto. For example, the information processing system 1 may include a reading unit (for example, an optical disc drive or a memory card slot) which reads a computer-readable information storage medium, or an input/output unit (for example, a USB port) for inputting and outputting data to/from an external device. For example, the program and the data stored in the information storage medium may be supplied to the information processing system 1 through intermediation of the reading unit or the input/output unit.

The information processing system 1 according to this embodiment identifies a household including a plurality of users. The information processing system 1 executes processing for acquiring more detailed information on the situation in the household and processing for identifying a relationship between households. As the acquisition processing, the information processing system 1 identifies types of relations between users, estimates whether or not a user has, for example, a spouse and/or a child based on information relating to the user, checks whether there is a user corresponding to the estimated spouse or child in the household, and registers a new user when there is no such user. In order to perform the acquisition processing, the information processing system 1 uses the types of relations between the user who is the target of the processing (hereinafter also referred to as “person of interest”) and users who have a relationship with the person of interest (such users are hereinafter also referred to as “reference person”).

Now, functions of the information processing system 1 according to this embodiment and processing to be executed by the information processing system 1 are further described.

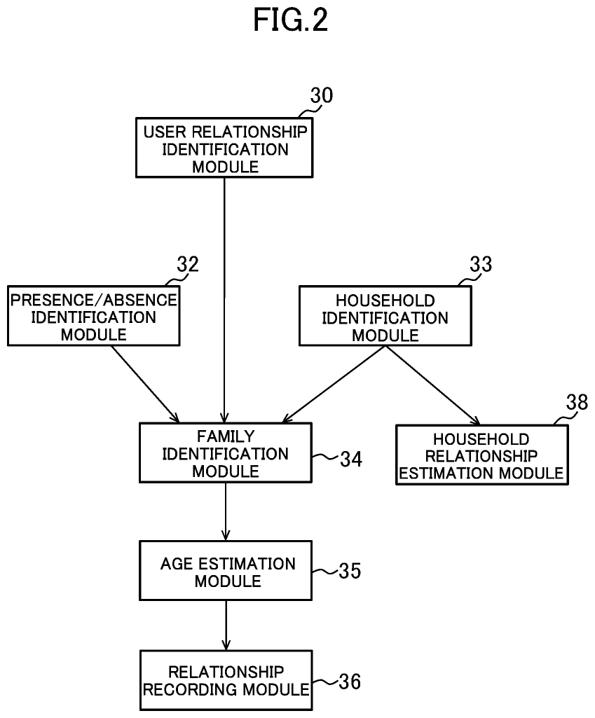

FIG. 2 is a functional block diagram for illustrating an example of the functions implemented by the information processing system 1 according to this embodiment. In the information processing system 1 according to this embodiment, not all the functions illustrated in FIG. 2 are required to be implemented, and a function other than the functions illustrated in FIG. 2 may be implemented.

As illustrated in FIG. 2, the information processing system 1 according to this embodiment functionally includes a user relationship identification module 30, a presence/absence identification module 32, a household identification module 33, a family identification module 34, an age estimation module 35, a relationship recording module 36, and a household relationship estimation module 38.

The user relationship identification module 30 is implemented mainly by the processor 10, the storage unit 12 and the communication unit 14. The presence/absence identification module 32, the household identification unit 33, the family identification module 34, the age estimation module 35, the relationship recording module 36, and the household relationship estimation unit 38 are implemented mainly by the processor 10 and the storage unit 12.

The above-mentioned functions may be implemented by the processor 10 executing programs including execution instructions corresponding to the above-mentioned functions, which are installed in the information processing system 1 being a computer. The programs may also be supplied to the information processing system 1, for example, through a computer-readable information storage medium, such as an optical disc, a magnetic disk, or a flash memory, or through the Internet or the like.

The user relationship identification module 30 identifies mainly relationship information indicating the type of a relation between users in a pair of users. The user relationship identification module 30 may output relationship information based on at least one of a family name, an IP address, a street address, an age difference, or a gender associated with the users included in the pair. The user relationship identification module 30 may also acquire relationship information created outside the information processing system 1. Herein, the user relationship identification module 30 can also be referred to as “relationship identification module.”

The presence/absence identification module 32 acquires presence/absence information indicating a presence/absence of a spouse, a child, or a parent of a target user based on information stored in association with the target user without being associated with other users. Further, the presence/absence identification module 32 estimates the presence/absence of a spouse of the target user, a child of the target user, or a parent of the target user based on an output of a machine learning model when the value of an input parameter relating to the target user is input to the machine learning model, and acquires presence/absence information indicating a result of the estimation. The input parameter is an item of information determined in advance and relating to a user, and the machine learning model may be trained by using learning data including the value of the input parameter.

The household identification module 33 acquires household information indicating one or a plurality of households each including one or a plurality of users living together. In this case, at least one of the one or the plurality of households may include the target user and one or a plurality of family users. The household identification module 33 may identify one or a plurality of family users who are included in the household including the target user and who are living with the target user from a plurality of users registered in the user database.

The family identification module 34 identifies, based on the relationship information, a family user indicated to be present by presence/absence information from among the family users included in the household indicated by the household information. The identified family user is one of a spouse, child, and a parent which presence/absence information indicates to be present.

The age estimation module 35 estimates, based on the information relating to the target user, the age of a spouse, child, or parent for which a corresponding family user is not identified among the spouse, child, or parent estimated to be present for the target user. Further, when a user corresponding to a spouse, child, or parent estimated to be present is identified, and the age of the user is not registered, the age estimation module 35 may estimate the age of that user. At this time, the age estimation module 35 may store the estimated age as information relating to the corresponding user, and the estimated age may be used for other processing.

The relationship recording module 36 stores the spouse, child, or parent for which a corresponding family user is not identified among the spouse, children, and/or parent estimated to be present of the target user as a new related user belonging to the household in the storage unit 12 in association with relationship information indicating the type of the relation between the related user and the target user.

The household relationship estimation module 38 estimates the type of the relation between a first household and a second household based on attributes of a user belonging to the first household and attributes of a user belonging to the second household. In this case, the first household and the second household are included in the one or the plurality of households identified by the household identification module 33. The household relationship estimation module 38 may estimate the type of the relation between the first household and the second household depending on whether the type of the relation between a first user included in the first household and a second user included in the second household is any of at least part of parent-child, sibling, and neighbor.

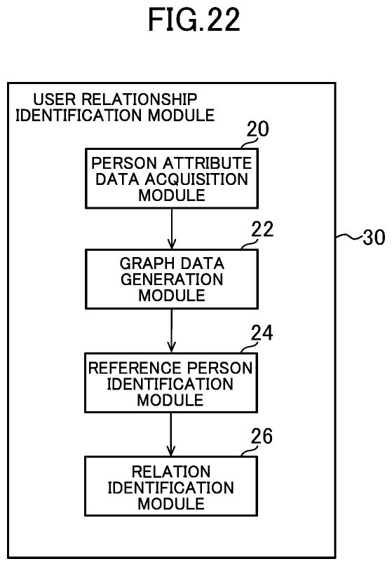

There is now given a description of the details of the user relationship identification module 30. FIG. 22 is a functional block diagram for illustrating an example of a functional configuration of the user relationship identification module 30. The user relationship identification module 30 includes a person attribute data acquisition module 20, a graph data generation module 22, a reference person identification module 24, and a relation identification module 26.

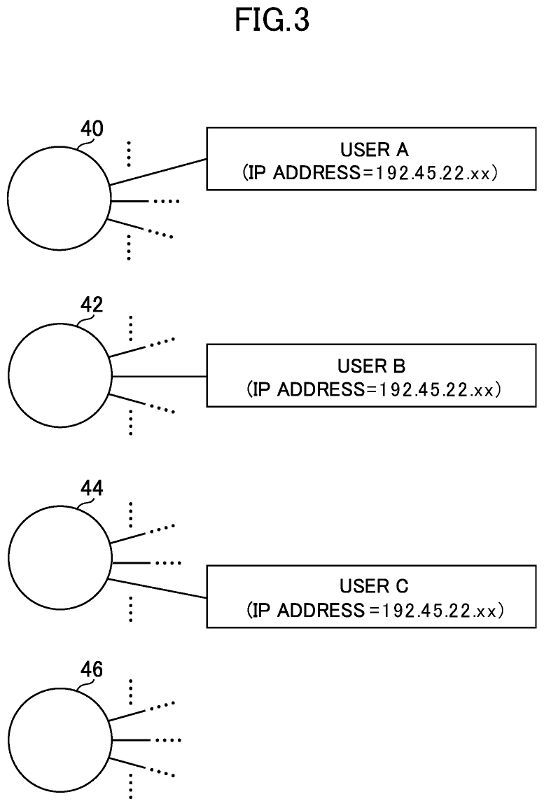

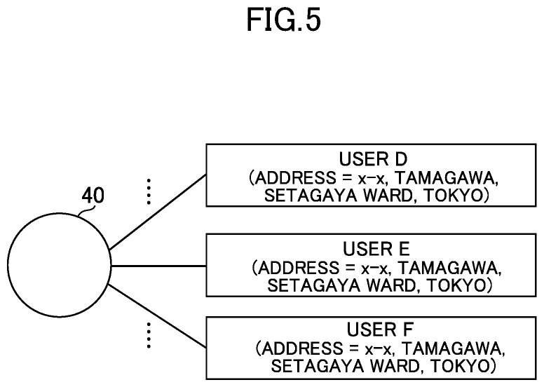

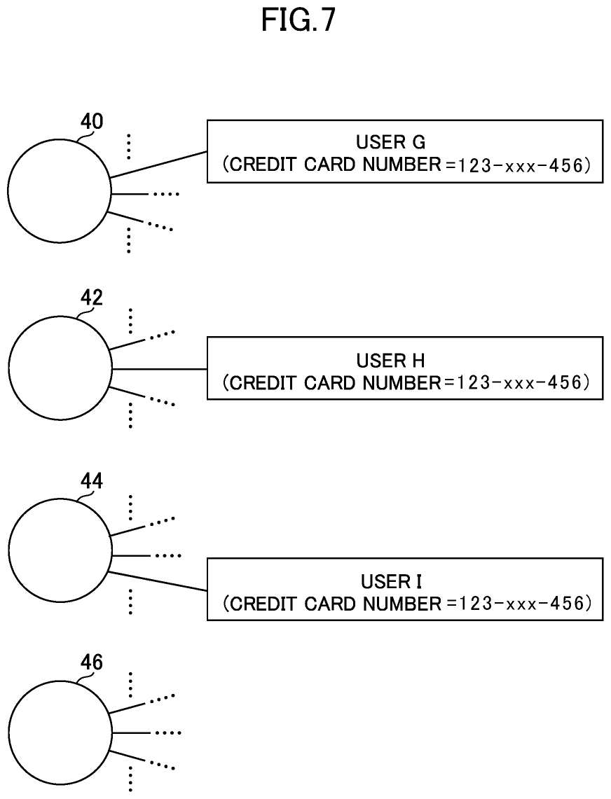

The person attribute data acquisition module 20 communicates to and from a plurality of computer systems, and acquires person attribute data indicating an attribute of a person. The information processing system 1 according to this embodiment can communicate to and from various computer systems such as an electronic commerce transaction system 40, a golf course reservation system 42, a travel reservation system 44, and a card management system 46, for example (see FIG. 3, FIG. 5, and FIG. 7). In each of those computer systems, account data, which is information relating to the users using the computer system, is registered. The information processing system 1 can access those computer systems and acquire the account data registered in the computer system. The various computer systems in this embodiment may include, for example, a payment management system, an online banking management system, a financial product management system, an insurance product management system, a mobile service management system, and the like. There are no restrictions on the type of system as long as the system is in a field in which a product or a service can be provided through the Internet.

The account data includes, for example, a user ID, full name data, street address data, age data, gender data, telephone number data, mobile phone number data, credit card number data, IP address data, and the like.

The user ID is, for example, identification information on the user in the computer system. The full name data is, for example, data indicating the full name (family name (surname) and given name) of the user. The street address data is, for example, data indicating the street address of the user. When the computer system is the electronic commerce transaction system 40, the street address data may indicate the street address of a delivery destination of the product purchased by the user. The age data is, for example, data indicating the age of the user. The gender data is, for example, data indicating the gender of the user. The telephone number data is, for example, data indicating the telephone number of the user. The mobile phone number data is, for example, data indicating the mobile phone number of the user. The credit card number data is, for example, data indicating the card number of the credit card used by the user for payment in the computer system. The IP address data is, for example, data indicating the IP address of the computer used by the user (for example, the IP address of the sender).

In this embodiment, for example, the person attribute data acquisition module 20 acquires person attribute data indicating an attribute of each of a plurality of persons, including the person of interest. An example of the person attribute data is the above-mentioned account data. The person attribute data acquisition module 20 acquires the account data, for example, of the person from each of the above-mentioned plurality of systems.

In this embodiment, for example, the graph data generation module 22 identifies pairs of persons having a relationship with each other based on the attributes of each of the plurality of persons. The graph data generation module 22 may identify a pair of persons having a relationship with each other based on the person attribute data of the plurality of persons. The graph data generation module 22 in this embodiment corresponds to an example of pair identification means for identifying a pair of persons having a relationship with each other based on an attribute of each of a plurality of persons.

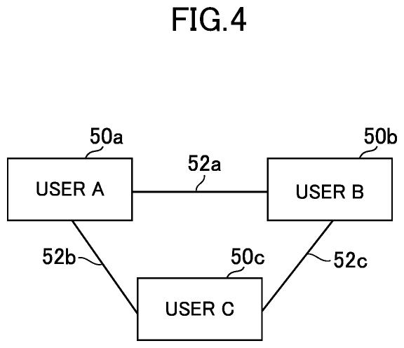

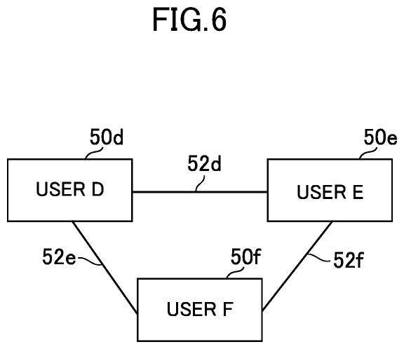

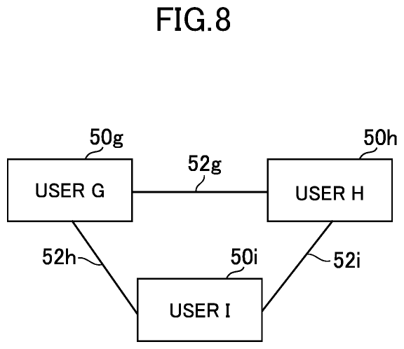

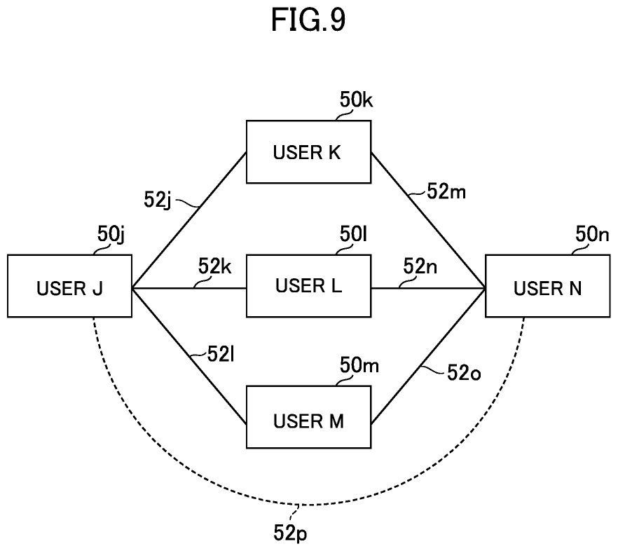

The graph data generation module 22 generates graph data including, for example, node data 50 associated with each of a plurality of persons including the person of interest and link data 52 associated with pairs of persons having a relationship with each other (see FIG. 4, FIG. 6, FIG. 8, and FIG. 9). The graph data generation module 22 stores the generated graph data in the storage unit 12.

For example, as illustrated in FIG. 3, it is assumed that the account data of a user A is registered in the electronic commerce transaction system 40, the account data of a user B is registered in the golf course reservation system 42, and the account data of a user C is registered in the travel reservation system 44.

Further, it is assumed that the value of the IP address data of the user A registered in the electronic commerce transaction system 40, the value of the IP address data of the user B registered in the golf course reservation system 42, and the value of the IP address data of the user C registered in the travel reservation system 44 are the same.

In this case, as illustrated in FIG. 4, the graph data generation module 22 generates graph data including node data 50a associated with the user A, node data 50b associated with the user B, node data 50c associated with the user C, link data 52a indicating that the user A has a relationship with the user B, link data 52b indicating that the user A has a relationship with the user C, and link data 52c indicating that the user B has a relationship the with user C.

Users having the same IP address are presumed to be using the same computer. Thus, in this embodiment, such users are associated with each other.

Further, for example, as illustrated in FIG. 5, it is assumed that the account data of a user D, a user E, and a user F are registered in the electronic commerce transaction system 40.

Then, it is assumed that the value of the street address data of the user D, the value of the street address data of the user E, and the value of the street address data of the user F registered in the electronic commerce transaction system 40 are the same.

In this case, as illustrated in FIG. 6, the graph data generation module 22 generates graph data including node data 50d associated with the user D, node data 50e associated with the user E, node data 50f associated with the user F, link data 52d indicating that the user D has a relationship with the user E, link data 52e indicating that the user D has a relationship with the user F, and link data 52f indicating that the user E has a relationship the with user F.

Users having the same street address are presumed to be living together. Thus, in this embodiment, such users are associated with each other.

Further, for example, as illustrated in FIG. 7, it is assumed that the account data of a user G is registered in the electronic commerce transaction system 40, the account data of a user H is registered in the golf course reservation system 42, and the account data of a user I is registered in the travel reservation system 44.

Further, it is assumed that the value of the credit card number data of the user G registered in the electronic commerce transaction system 40, the value of the credit card number data of the user H registered in the golf course reservation system 42, and the value of the credit card number data of the user I registered in the travel reservation system 44 are the same.

In this case, as illustrated in FIG. 8, the graph data generation module 22 generates graph data including node data 50g associated with the user G, node data 50h associated with the user H, node data 50i associated with the user I, link data 52g indicating that the user G has a relationship with the user H, link data 52h indicating that the user G has a relationship with the user I, and link data 52i indicating that the user H has a relationship the with user I.

Users having the same credit card number are presumed to be a family, for example, a parent and child. Thus, in this embodiment, such users are associated with each other.

It should be noted that the criteria for determining whether or not a person corresponds to a pair of persons having a relationship with each other are not limited to the criteria described above.

Further, the above-mentioned links indicated by the link data 52 associating the persons identified as having a relationship with each other are referred to as “explicit links.”

In this case, for example, it is assumed that there are a predetermined number or more of persons in common (for example, three persons or more) between the persons connected to a first person by an explicit link and the persons connected to a second person by an explicit link. In this case, in this embodiment, for example, the graph data generation module 22 generates link data 52 indicating that those first persons have a relationship with those second persons. A link indicated by the link data 52 generated in this way is referred to as “implicit link.”

For example, as illustrated in FIG. 9, it is assumed that node data 50j associated with a user J and node data 50k associated with a user K are connected by link data 52j indicating an explicit link, the node data 50j associated with the user J and node data 501 associated with a user L are connected by link data 52k indicating an explicit link, and the node data 50j associated with the user J and node data 50m associated with a user M are connected by link data 521 indicating an explicit link.

Further, it is assumed that the node data 50k associated with the user K and node data 50n associated with a user N are connected by link data 52m indicating an explicit link, the node data 501 associated with the user L and the node data 50n associated with the user N are connected by the link data 52n indicating an explicit link, and the node data 50m associated with the user M and the node data 50n associated with the user N are connected by link data 52o indicating an explicit link.

In this case, the graph data generation module 22 generates link data 52p (link data 52p indicating an implicit link) indicating that the user J has a relationship with the user N. In this way, the user N is identified as a person having a relationship with the user J.

Further, for example, it is assumed that there are a predetermined number or more of persons in common (for example, three persons or more) between the persons connected to a first person by an explicit link or an implicit link and the persons connected to a second person by an explicit link or an implicit link. In this case, the graph data generation module 22 may generate link data 52 (link data 52 indicating an implicit link) indicating that those first persons have a relationship with those second persons.

The graph data generation module 22 may generate graph data based on person attribute data different from the account data.

The reference person identification module 24 identifies a reference person, who is a person having a relationship with a processing target person (including the person of interest, for example). In this case, the reference person identification module 24 may identify, as a reference person, a person identified as a person having a relationship with the processing target person (for example, a person registered as a friend in the electronic commerce transaction system 40 or the like), and a person having a predetermined number of persons or more of persons (for example, registered friends) identified as persons having a relationship in common with the processing target person. Further, the reference person identification module 24 may identify, based on an attribute of the processing target person and an attribute of a plurality of persons, the reference person from among the plurality of persons.

For example, the reference person identification module 24 may identify a person associated with node data 50 connected by link data 52 indicating an explicit link or an implicit link to the node data 50 associated with the processing target person as a reference person for the processing target person.

The relation identification module 26 identifies the relation between the processing target person (including the person of interest, for example) and the reference person. In this case, the relation identification module 26 may identify the relation between the processing target person and the reference person based on the account data of the processing target person and the account data of the reference person. In this case, the computer system in which the account data of the processing target person is registered may be different from the computer system in which the account data of the reference person is registered. For example, the relation (more specifically, the type of the relation) between the processing target person and the reference person may be identified based on the account data of the processing target person registered in the electronic commerce transaction system 40 and the account data of the reference person registered in the golf course reservation system 42. The relation identification module 26 may store the identified relation type in the storage unit 12 in association with the pair of the processing target person and the reference person.

Further, the relation identification module 26 may identify a family relationship (for example, parent-child, spouse, sibling) between the processing target person and the reference person. Moreover, the relation identification module 26 may select, as the type of the relation to be identified, any one of candidates including at least part of parent-child, spouse, sibling, colleague, neighbor, and friend.

Next, processing of the relation identification module 26 is described in more detail. The relation identification module 26 identifies a pair of node data 50 connected by link data 52, for example. Then, the relation identification module 26 generates pair attribute data associated with the pair based on the person attribute data of the two persons associated with the pair.

The pair attribute data includes, for example, a common IP flag, a common street address flag, a common credit card number flag, a same-surname flag, age difference data, pair gender data, and the like.

The common IP flag is, for example, a flag indicating whether or not the value of the IP address data included in the account data of one person in the pair is the same as the value of the IP address data included in the account data of the other person in the pair. For example, when the values of the IP address data are the same on a given day, the value of the common IP flag may be set to 1, and when values of the IP address data are different, the value of the common IP flag may be set to 0.

The common street address flag is, for example, a flag indicating whether or not the value of the street address data included in the account data of one person in the pair is the same as the value of the street address data included in the account data of the other person in the pair. For example, when the values of the street address data are the same, the value of the common street address flag may be set to 1, and when the values of the street address data are different, the value of the common street address flag value may be set to 0. Further, a similarity between street addresses may be used as the common street address flag. For example, the common street address flag may be set to 0 when the street name and street number are also different, set to 1 when the building name and room number after the street number are different, and set to 2 when the building name and room number are the same.

The common credit card number flag is, for example, a flag indicating whether or not the value of the credit card number data included in the account data of one person in the pair is the same as the value of the credit card number data included in the account data of the other person in the pair. For example, when the values of the credit card number data are the same, the value of the common credit card number flag may be set to 1, and when the values of the credit card number data are different, the value of the common credit card number flag value may be set to 0.

The same-surname flag is, for example, a flag indicating whether or not the surname indicated by the full name data included in the account data of one person in the pair is the same as the surname indicated by the full name data included in the account data of the other person in the pair. For example, when the surnames indicated by the full name data are the same, the value of the same-surname flag may be set to 1, and when the surnames indicated by the full name data are different, the value of the same-surname flag value may be set to 0.

The age difference data is, for example, data indicating the difference between the value of age data included in the account data of one person in the pair and the value of age data included in the account data of the other person in the pair.

The pair gender data is, for example, data indicating the combination of the value of gender data included in the account data of one person in the pair and the value of gender data included in the account data of the other person in the pair.

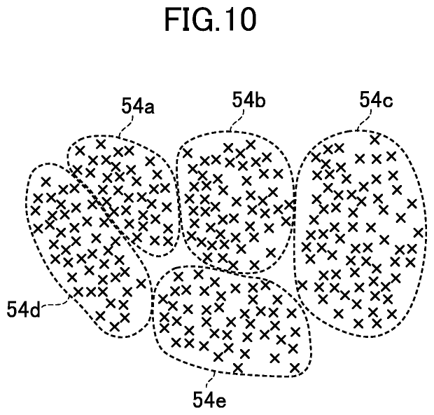

Further, the relation identification module 26 classifies a plurality of pairs into a plurality of clusters 54 like those illustrated in FIG. 10 by executing clustering using a general clustering method based on the values of the pair attribute data associated with each of the plurality of pairs.

FIG. 10 is a diagram for schematically illustrating an example of how a plurality of pairs are classified into five clusters 54 (54a, 54b, 54c, 54d, and 54e). The cross marks illustrated in FIG. 10 correspond to pairs. Each of the plurality of cross marks is arranged at a position associated with the value of the pair attribute data of the pair corresponding to the cross mark.

In the example of FIG. 10, a plurality of pairs are classified into five clusters 54, but the number of clusters 54 into which a plurality of pairs are classified is not limited to five. For example, the plurality of pairs may be classified into four clusters 54.

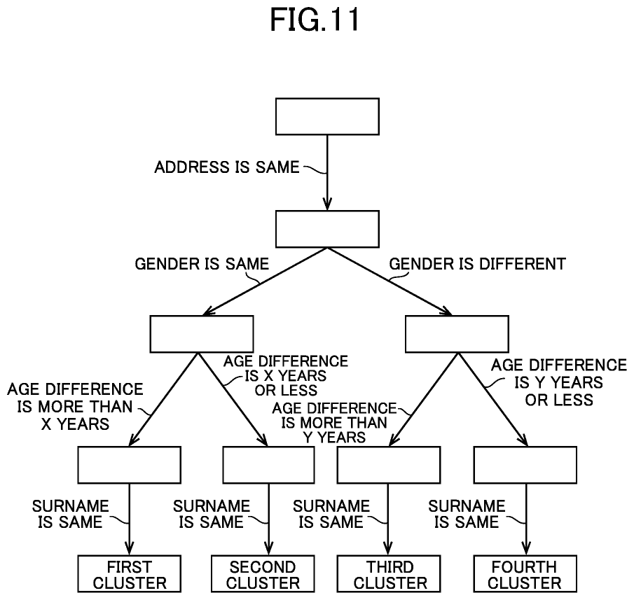

FIG. 11 is a diagram for illustrating an example of visualization of the classification in the case in which a plurality of pairs are classified into four clusters 54.

As illustrated in FIG. 11, pairs having the same street address, the same gender, an age difference of more than X years, and the same surname may be classified into a first cluster. Pairs having the same street address, the same gender, an age difference of X years or less, and the same surname may be classified into a second cluster. Pairs having the same street address, different genders, an age difference of more than Y years, and the same surname may be classified into a third cluster. Pairs having the same street address, different genders, an age difference of Y years or less, and the same surname may be classified into a fourth cluster.

In this case, the first cluster is presumed to be, for example, a cluster 54 associated with a parent-child pair of the same gender. The second cluster is presumed to be, for example, a cluster 54 associated with siblings of the same gender. The third cluster is presumed to be, for example, a cluster 54 associated with a parent-child pair of the opposite gender. The fourth cluster is presumed to be, for example, a cluster 54 associated with a married couple or siblings of the opposite gender.

In addition, the number of friends in common between one of the persons in the pair and the other person in the pair may be used to identify the type of the relation between the processing target person and the reference person.

In the way described above, the relation identification module 26 may identify the type of the relation between the processing target person and the reference person based on the results of clustering performed based on values associated with the relationship between persons. Further, the relation identification module 26 may identify the type of the relation between the processing target person and the reference person based on the results of clustering performed based on at least one of the surname, the IP address, the street address, the credit card number, the age difference, or the gender.

The relation identification module 26 may identify the type of the relation between the processing target person and the reference person further based on a record of an exchange of information or an object between the processing target person and the reference person. The record of an exchange of information or an object may be, for example, a history of sending a gift on a specific date, for example, Father's Day, Mother's Day, or Christmas, or a log of messages sent and received on that specific date.

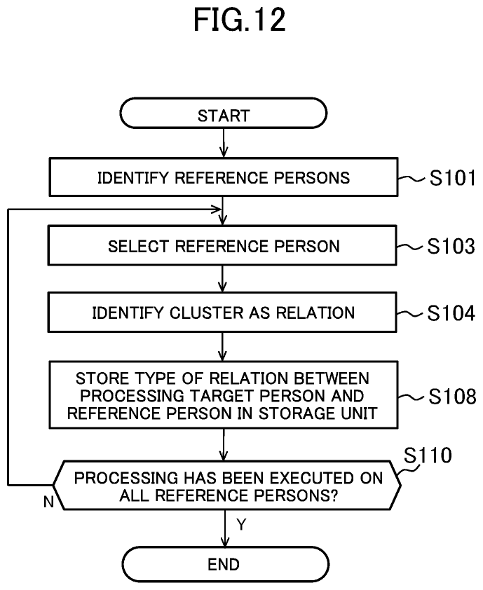

An example of processing for creating information relating to a social graph performed by the information processing system 1 according to this embodiment is now described with reference to a flow chart illustrated in FIG. 12. In FIG. 12, there is illustrated processing of mainly the reference person identification module 24 and the relation identification module 26.

The processing illustrated in FIG. 12 is repeatedly executed for each person for which graph data has been generated. Graph data is generated for persons including the person of interest. The person that is the target of the processing of FIG. 12 is hereinafter referred to as “processing target person.” In the processing example of FIG. 12, it is assumed that graph data for a plurality of persons, including the person of interest, has already been generated, and the clusters 54 associated with a plurality of pairs have been identified. It is also assumed that a closeness machine learning model associated with each cluster 54 has already been trained.

First, the reference person identification module 24 identifies, as reference persons, persons corresponding to the node data 50 connected by an explicit or implicit link to the node data 50 corresponding to the processing target person (Step S101). In this case, for example, it is assumed that at least one reference person is identified.

Then, the relation identification module 26 selects one reference person for which the processing steps of Step S104 to Step S108 have not yet been executed from among the reference persons identified in the processing step of Step S101 (Step S103).

Then, the relation identification module 26 identifies the cluster 54 corresponding to the pair of the processing target person and the reference person selected in the processing step of Step S102 as the type of the relation of that pair (Step S104).

The relation identification module 26 stores the type of the relation between the processing target person and the reference person in the storage unit 12 (Step S108).

Then, the relation identification module 26 checks whether the processing steps of Step S104 and Step S108 have been executed for all the reference persons identified in the processing step of Step S101 (Step S110).

When the processing steps of Step S104 and Step S108 have not been executed for all of the reference persons identified in the processing step of Step S101 (“N” in Step S110), the process returns to the processing step of Step S103.

When the processing steps of Step S104 and Step S108 have been executed for all of the reference persons identified in the processing step of Step S101 (“Y” in Step S110), the processing of FIG. 12 is ended.

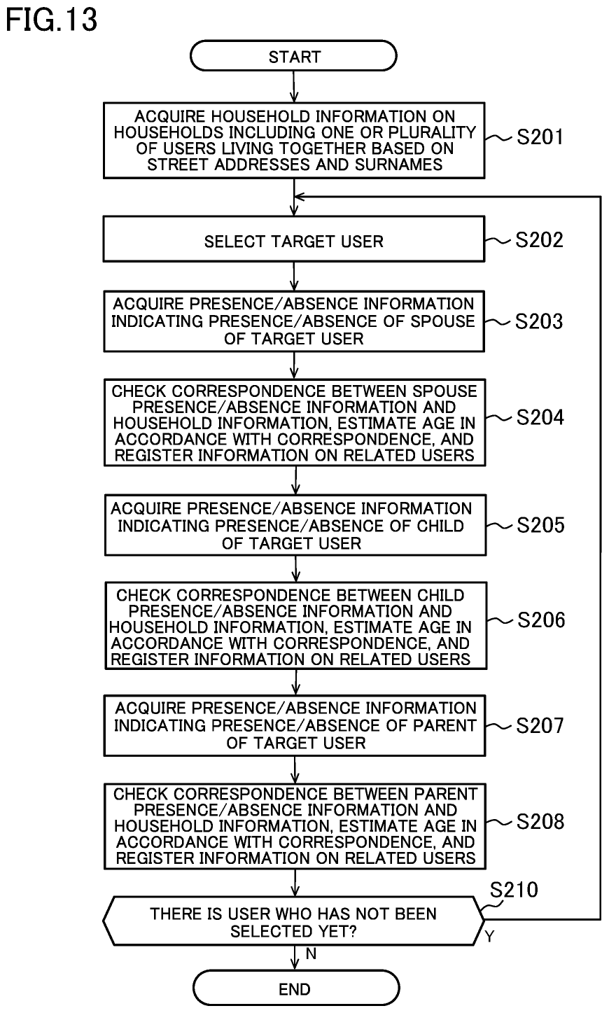

Next, a more detailed description is given of the processing for acquiring the situation in the household in more detail. FIG. 13 is a flow chart for illustrating an example of processing involved in identifying the family relationship of the users in a household. The processing illustrated in FIG. 13 is executed by the presence/absence identification module 32, the household identification module 33, the family identification module 34, the age estimation module 35, and the relationship recording module 36.

First, the household identification module 33 acquires household information on households including one or a plurality of users living together based on the street addresses and the surnames of the users (Step S201). More specifically, the household identification module 33 acquires the account data of a plurality of users registered in user databases of a plurality of computer systems. Then, the household identification module 33 selects a plurality of users having the same street address and surname included in the account data as users included in the household and living together, and generates household information on households including those selected users. The household identification module 33 may also generate household information on households in which there are no users having the same street address and surname. It is not required that the condition for selecting users included in the household and living together be only a condition that the street address and the surname are the same. For example, the condition may be that the street address matches and is highly similar except for the building name and that the surnames match. The household identification module 33 may acquire household information on households including users included in a target user group set as a target for the processing in advance, or may acquire household information on a plurality of households without a target user group being set and regardless of the target user. The user databases may be acquired in advance from a plurality of computer systems and stored in the storage unit 12, or may be generated separately and stored in the storage unit 12.

When the household information is acquired, the family identification module 34 selects one target user to be the target of processing for identifying family users (Step S202). In the processing, the family identification module 34 may select the target user from the users included in the target user group to be processed by the household identification module 33, or the family identification module 34 may select any user included in the plurality of households acquired by the household identification module 33.

Next, the presence/absence identification module 32 acquires presence/absence information indicating the presence/absence of a spouse of the target user based on information stored in association with the target user without being associated with other users (Step S203). In this case, the presence/absence identification module 32 estimates the presence/absence of a spouse of the target user based on the output of a spouse presence/absence estimation model obtained when the value of the input parameter relating to the target user is input to the spouse presence/absence estimation model and the presence/absence identification module 32 acquires presence/absence information indicating a result of the estimation. The spouse presence/absence estimation model is a machine learning model. In this case, the input parameter is an item of information determined in advance and relating to the user. The spouse presence/absence estimation model may be trained in advance by using learning data including the value of the input parameter. The details of the spouse presence/absence estimation model are described later.

Then, the family identification module 34 checks a correspondence between the spouse presence/absence information and the users in the household, the age estimation module 35 estimates an age in accordance with the correspondence, and the relationship recording module 36 registers the information on the related users (Step S204). The details of the processing step of Step S204 are described later.

In the same way as in Step S203, the presence/absence identification module 32 acquires presence/absence information indicating the presence/absence of a child of the target user based on information stored in association with the target user without being associated with other users (Step S205). The presence/absence identification module 32 estimates the presence/absence of a child, or more specifically, the number of children, of the target user based on the output of a child presence/absence estimation model obtained when the value of the input parameter relating to the target user is input to the child presence/absence estimation model, and acquires presence/absence information indicating a result of the estimation. The child presence/absence estimation model is a machine learning model trained in advance.

In the same way as in Step S204, the family identification module 34 checks a correspondence between the child presence/absence information and the users in the household, the age estimation module 35 estimates age(s) in accordance with the correspondence, and the relationship recording module 36 registers the information on the related users (Step S206).

In the same way as in Step S203, the presence/absence identification module 32 acquires presence/absence information indicating the presence/absence of a parent of the target user based on information stored in association with the target user without being associated with other users (Step S207). The presence/absence identification module 32 estimates the presence/absence of a parent, or more specifically, the number of parents, of the target user based on the output of a parent presence/absence estimation model obtained when the value of the input parameter relating to the target user is input to the parent presence/absence estimation model, and acquires presence/absence information indicating a result of the estimation. The parent presence/absence estimation model is a machine learning model trained in advance.

In the same way as in Step S204, the family identification module 34 checks a correspondence between the parent presence/absence information and the users in the household, the age estimation module 35 estimates age(s) in accordance with the correspondence, and the relationship recording module 36 registers the information on the related users (Step S208).

Then, the family identification module 34 determines whether or not there is a user who has not been selected yet (Step S210). When there is a user who has not been selected (“Y” in Step S210), the processing is repeated from Step S202. When all users have been selected (“N” in Step S210), the processing of FIG. 13 is ended.

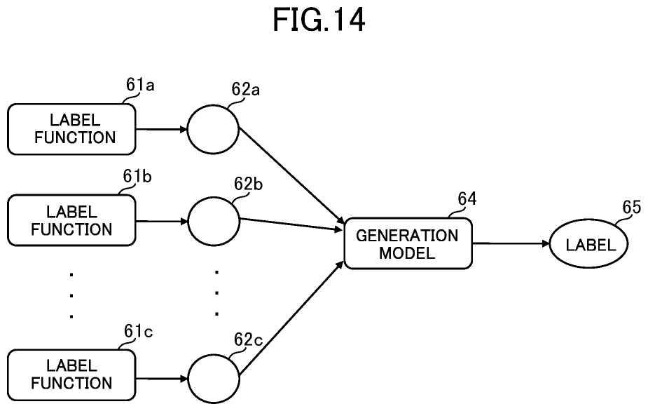

Next, the spouse presence/absence estimation model, the child presence/absence estimation model, and the parent presence/absence estimation model included in the presence/absence identification module 32 are described. The spouse presence/absence estimation model, the child presence/absence estimation model, and the parent presence/absence estimation model are collectively referred to as “presence/absence estimation models.” In this embodiment, the input parameter relating to the presence/absence estimation model may include, for example, a usage history such as a transaction history relating to various computer systems, and may include at least part of the person attribute data relating to the target user. FIG. 14 is a diagram for illustrating an example of the presence/absence estimation model, which is a machine learning model used by the presence/absence identification module 32. The presence/absence estimation model is trained by using weakly supervised learning. The presence/absence estimation model includes a plurality of label functions 61a to 61c (referred to as “label function 61” unless otherwise distinguished) and a generation model 64. Outputs 62a to 62c of the label functions 61a to 61c (referred to as “output 62” unless distinguished otherwise) are input to the generation model 64, and the generation model 64 outputs a label 65 indicating the presence/absence estimation result. In this case, there is no particular limit on the number of label functions (corresponding to labeling functions). The machine learning model illustrated in FIG. 14 may be a publicly known machine learning model provided under the name “Snorkel,” for example. The label 65 determined by the presence/absence estimation model may be the output of each label function 61, or information estimated based on statistical information which is obtained by statistically processing the output by a predetermined method, or information determined on a rule basis such as majority vote in accordance with statistical information based on the output of each label function 61.

Each of the plurality of label functions 61 included in the spouse presence/absence estimation model outputs a score relating to whether or not the target user has a spouse based on one or a plurality of input parameters relating to the user. Each of the plurality of label functions 61 included in the child presence/absence estimation model outputs a score relating to whether or not the target user has a child based on one or a plurality of input parameters relating to the user. Each of the plurality of label functions 61 included in the parent presence/absence estimation model outputs a score relating to whether or not the target user has a parent based on one or a plurality of input parameters relating to the user. The input parameters include information associated with the user and not associated with other users.

The generation model 64 calculates the score of the label 65 from the outputs 62 in accordance with a weight of each label function 61. The generation model 64 estimates the presence/absence of a spouse (child, parent) of the target user based on the outputs of the plurality of label functions 61 and the weights of the plurality of functions determined by learning, and determines presence/absence information indicating a result of the estimation.

The label function 61 is a function which generates an output 62 that is a temporary label for the input parameter. The label function 61 may be determined by an administrator, for example. The value of the output 62 may be, for example, any one of the three value of negative (0), positive (1), or skip, or may be some kind of value and skip. The accuracy of the output 62 generated by the label function 61 is not necessarily required to be high. The generation model 64 is trained to minimize loss based on label probabilities calculated for the plurality of outputs 62 of the plurality of label functions 61. In learning, for example, a weight for each output 62 of the label function 61 may be determined. Moreover, the machine learning model can learn even without the existence of labels as ground truths.

In the spouse presence/absence estimation model, for example, the following label function 61 may be provided. One of the label functions 61 may output “positive” when the travel reservation system 44 includes a travel reservation history for two adults by the user, and output “negative” when the travel reservation system 44 does not include such a travel reservation history. Another one of the label functions 61 may output “positive” when information relating to a child of the user is registered in the member information of the electronic commerce transaction system 40, and output “negative” when such information is not registered. Another one of the label functions 61 may output “positive” when the registration information of the card management system 46 includes information that the user is married and has a child or that the user is married, and may output “negative” when such information is not registered.

In the child presence/absence estimation model, for example, the following label functions 61 may be provided. One of the label functions 61 may output the number of children for which a reservation is most frequently made in the history present in the travel booking system 44. Another one of the label functions 61 may output the number of children of the user registered in the member information of the electronic commerce transaction system 40. Another one of the label functions 61 may output the number of children stored in the registration information of the card management system 46. The number of children may be output as any one of “0”, “1”, “2”, or “3 or more.”

In the parent presence/absence estimation model, for example, the following label functions 61 may be provided. One of the label functions 61 may output the number of persons having the same street address as that of the user in a contact address registered in a computer system. Another one of the label functions 61 may output the number of parents stored in the registration information of the card management system 46. The number of parents may be output as any one of “0”, “1”, or “2”.

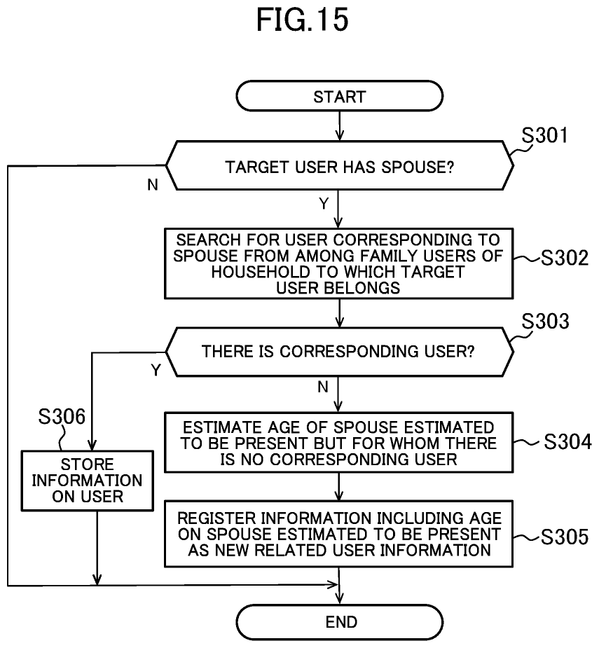

Next, the processing step of Step S204 is described in further detail. FIG. 15 is a flow chart for illustrating an example of processing of the family identification module 34, the age estimation module 35, and the relationship recording module 36, and in particular, an example of processing relating to the presence/absence of a spouse. The age estimation models such as the spouse age estimation model, the child age estimation model, and the parent age estimation model included in the age estimation module 35 have the same configuration as that of the presence/absence estimation model, and a publicly known model provided under the name “Snorkel”, for example, can be used. The age estimation model may be a model which estimates age by using the output of the label function (corresponding to a labeling function) to which each input parameter is given.

First, the family identification module 34 determines whether or not the presence/absence identification module 32 has estimated that the target user has a spouse (Step S301). When it is estimated that the target user does not have a spouse (“N” in Step S301), the processing of FIG. 15 is ended. Meanwhile, when it is determined that the target user has a spouse (“Y” in Step S301), the family identification module 34 retrieves a user corresponding to a spouse from among the users in the family of the household to which the target user belongs, the users indicated by the household information (Step S302). More specifically, the family identification module 34 searches for the user who has “spouse” as the type of the relation with the target user from among the users (family users) included in the same household as that of the target user. The users are indicated by the household information. In this case, the type of the relation between the target user and the family users may be identified in advance by the user relationship identification module 30. The family identification module 34 then determines whether or not there is a corresponding user (Step S303).

When there is no corresponding user (“N” in Step S303), the age estimation module 35 estimates the age of the spouse estimated to be present by the presence/absence identification module 32 but for whom there is no corresponding user (Step S304).

The age estimation module 35 estimates the age of the spouse estimated to be present by inputting input parameters relating to the user into a spouse age estimation model, which is a machine learning model. To the spouse age estimation model, as an example, input data including the age and gender of the target user and usage histories of various computer systems such as a purchase history and a browsing history of the electronic commerce transaction system 40 are input, and the spouse age estimation model may output the estimated age of the spouse. The spouse age estimation model may be trained by using input data including the age and gender of one of the users estimated to be the spouse of another user by the user relationship identification module 30 and the usage histories of various computer systems such as the purchase history and the browsing history of the electronic commerce transaction system 40, and learning data having the tier of the age of the other user as ground truth data. The age tiers may be set such that each tier includes a five-year range, for example.

When the age has been estimated, the relationship recording module 36 registers the information (including age) on the spouse estimated to be present by the presence/absence identification module 32 as new related user information (Step S305). When there is already a user corresponding to the spouse estimated to be present by the presence/absence identification module 32 (“Y” in Step S303), the relationship recording module 36 stores the information on the user in the storage unit 12 (Step S306). When information is to be added to an existing user database in Step S305, Step S306 is not required to be executed.

The processing step of Step S206 is similar to the processing illustrated in FIG. 15, but children are the target of the processing instead of a spouse. The following description focuses on the major processing differences. In Step S301, the family identification module 34 determines whether or not the presence/absence identification module 32 has estimated that the target user has a child. When it is estimated that the target user has a child (“Y” in Step S301), the family identification module 34 retrieves (the estimated number of) user corresponding to children from among the users in the family of the household to which the target user belongs. The users are indicated by the household information. When there is a non-corresponding user (“N” in Step S303), the age estimation module 35 estimates the age of the child estimated to be present by the presence/absence identification module 32 but for whom there is no corresponding user (Step S304).

The age estimation module 35 estimates the age of the child estimated to be present by inputting input parameters relating to the user into a child age estimation model, which is a machine learning model. The child age estimation model may be a weakly supervised machine learning model as illustrated in FIG. 14. One of the label functions 61 included in the child age estimation model may output an age tier based on information on the children included in the member information of the electronic commerce transaction system 40, for example. Another one of the label functions may output an age tier based on information on children's meals and bedding included in lodging reservations included in the travel reservation system 44. Another one of the label functions may output an age tier based on the types of products included in the purchase history of the electronic commerce transaction system 40. In this case, the label 65 may be information indicating the age tier of a child for which his or her age has been estimated. The child age estimation model may be trained by using input data including the ages and genders of the parents among the users estimated to be parents or children by the user relationship identification module 30 and the usage histories of various computer systems such as the purchase history and the browsing history of the electronic commerce transaction system 40, and learning data having age tiers of the children as ground truth data.

When the age has been estimated, the relationship recording module 36 registers the information (including age) on the child estimated to be present by the presence/absence identification module 32 as new related user information (Step S305).

The processing step of Step S208 is similar to the processing illustrated in FIG. 15, but parents are the target of the processing instead of a spouse. The following description focuses on the major processing differences. In Step S301, the family identification module 34 determines whether or not the presence/absence identification module 32 has estimated that the target user has a parent. When it is estimated that the target user has a parent (“Y” in Step S301), the family identification module 34 retrieves (the estimated number of) users corresponding to parents from among the users indicated by the household information in the family of the household to which the target user belongs. When there is a non-corresponding user (“N” in Step S303), the age estimation module 35 estimates the age of the parent estimated to be present by the presence/absence identification module 32 but for whom there is no corresponding user (Step S304).

The age estimation module 35 estimates the age of the parent estimated to be present by inputting input parameters relating to the user into a parent age estimation model, which is a machine learning model. The parent age estimation model may be a weakly supervised machine learning model as illustrated in FIG. 14. One of the label functions 61 included in the parent age estimation model may output a parent age tier based on the age of the target user. Another one of the label functions 61 may output an age tier based on the types of products included in the purchase history of the electronic commerce transaction system 40. In this case, the label 65 may be information indicating the age tier of a parent for which his or her age has been estimated. The parent age estimation model may be trained by using input data including the ages and genders of the children among the users estimated to be parents or children by the user relationship identification module 30 and the usage histories of various computer systems such as the purchase history and the browsing history of the electronic commerce transaction system 40, and learning data having age tiers of the parents as ground truth data.

When the age has been estimated, the relationship recording module 36 registers the information (including age) on the parent estimated to be present by the presence/absence identification module 32 as new related user information (Step S305).

The processing described so far not only clarifies the relationships among the plurality of users included in the household, but also enables detection of person who is present in the household but is not registered as a user.

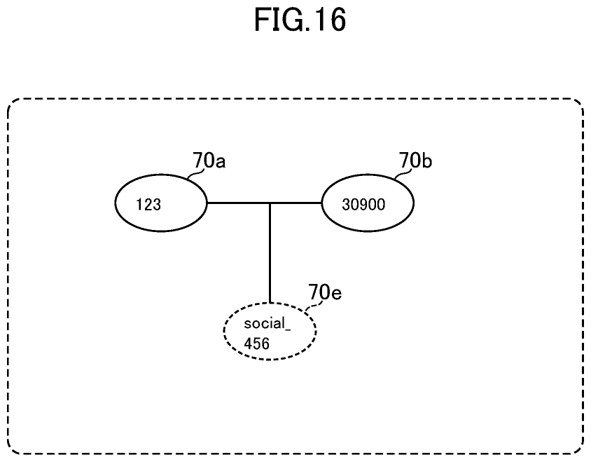

FIG. 16 is a diagram for illustrating the relationships between users or the like in a household. In this example, a range surrounded by a dashed-line rectangle indicates a household, and the household includes users 70a and 70b and a related user 70e. The character strings written in the ellipses of the users 70a and 70b indicate user IDs, and the character string written in the ellipse of the related user 70e indicates the user ID given when the relationship recording module 36 records the related user. Further, users (or related users) connected only by a horizontal line indicate that the users are spouses, and users (or related users) connected by a vertical line extending downward from the horizontal line indicate children.

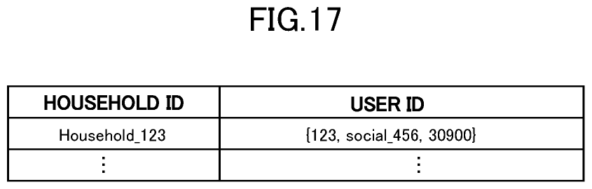

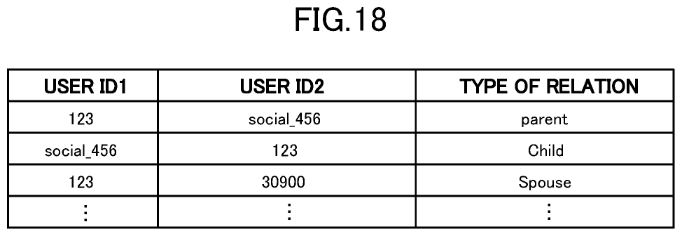

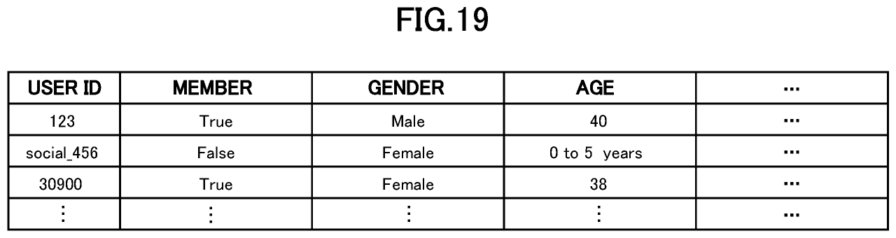

A description is now further given of the structure of the data output by the relationship recording module 36. FIG. 17 is a table for showing an example of information stored in a household member table. FIG. 18 is a table for showing an example of information stored in a user relationship table. FIG. 19 is a table for showing an example of information stored in a member attribute table. The household member table, the user relationship table, and the member attribute table may be stored in the storage unit 12. Further, instead of the storage unit 12, those tables may be stored in a database in another member management system.

The household member table stores, for each household, a household ID for identifying the household and the user IDs of one or a plurality of users belonging to the household. As the user ID, the user IDs of related users registered by the relationship recording module 36 (social 456 in the example of FIG. 17) are also registered.

The user relationship table stores, for each user pair, a user ID1 and a user ID2 of the users included in the pair, and the type of the relation between the pair. The user pair may be a pair identified by the user relationship identification module 30, or a pair of the target user and a related user (in FIG. 18, a pair of user ID 1: social 456 and user ID 2: 123).

The member attribute table stores the attributes of each of users and related users. The attributes of each of the users include a flag indicating whether or not the user is a member, and the gender and the age of the user. In the case of each of the related users, the flag indicating whether or not the related user is a member is “False.” For related users, the age tier estimated by the age estimation module 35 is stored as the age.

In this way, by estimating the presence of related users and outputting the information on the related users, it becomes possible to manage not only users who already have account data, but also related users in the household estimated from existing users. Further, each of the computer systems including the information processing system 1 and the electronic commerce transaction system 40 may recommend products, services, and the like based on the information on the users and related users in each household.

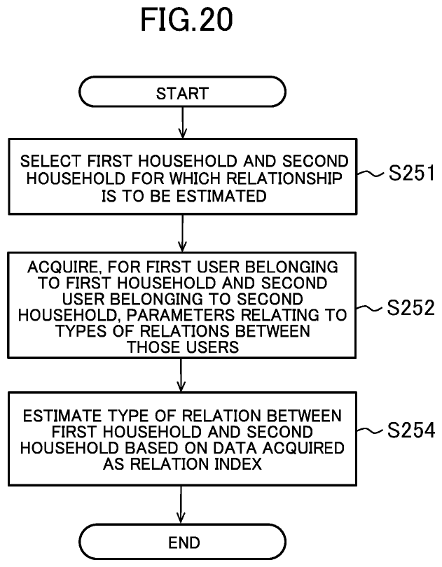

A more detailed description is now given of the processing for identifying relationships between households. FIG. 20 is a flow chart for illustrating an example of processing for estimating relationships between households. The processing illustrated in FIG. 20 is executed by the household relationship estimation module 38. The processing illustrated in FIG. 20 is executed after the processing by the household identification module 33, in other words, the processing step of Step S201 of FIG. 13, is executed. The processing illustrated in FIG. 20 may be executed repeatedly for each pair of a plurality of households identified by the household identification module 33, or may be executed once for pairs of a plurality of households.

First, the household relationship estimation module 38 selects a pair of a first household and a second household for which a relationship is to be estimated (Step S251).

Then, the household relationship estimation module 38 acquires, for the first user belonging to the first household and the second user belonging to the second household, parameters relating to the types of the relations between those users (Step S252). The parameters may include at least a part of information based on attributes of the first user and attributes of the second user, and information based on interactions between the first user and the second user. Examples of information based on attributes of the first user and attributes of the second user include whether or not the surname is the same, the age difference, whether or not the gender is the same, and similarity in the street addresses (for example, whether or not the municipality, suburb, and street are the same). Examples of information based on interactions between the first user and the second user include the presence or absence of sending gifts relating to specific days (Father's Day, Mother's Day, or Christmas), the presence or absence of sending and receiving messages on specific dates, a frequency of sending a gift to each other, and the number of friends in common. The parameter relating to the type of the relation may be information selected in advance from the above-mentioned information.

The household relationship estimation module 38 estimates the type of the relation between a pair of the first household and the second household based on parameters relating to the types of relations between those households (Step S254). The household relationship estimation module 38 may select any one parameter from among candidates including at least part of parent-child, sibling, friend, colleague, and neighbor as the type of the relation to be estimated.

The household relationship estimation module 38 may estimate the household relationship by using use the same method as that of the relationship identification module 26. More specifically, the household relationship estimation module 38 may classify a plurality of household pairs into a plurality of clusters 54 like those illustrated in FIG. 10 by executing clustering using a general clustering method based on the values of the parameters acquired for each of the plurality of household pairs. The household relationship estimation module 38 may then select the type of the relation corresponding to the cluster 54 to which the first and second households belong as the type of the relation between the first and second households.

The parameters used for the type of the relation by the household relationship estimation module 38 may include not only information relating to one first user belonging to the first household and one second user belonging to the second household, but also information relating to another first user belonging to the first household and information relating to another second user belonging to the second household. The parameters may include a combination of information based on an attribute of one of the first users and one of the second users (for example, age difference) and information relating to an interaction of another first user with another second user (for example, whether or not a gift is sent on a specific day).

Further, the household relationship estimation module 38 may estimate the type of the relation between the first household and the second household by using a household relationship estimation model, which is a machine learning model. The household relationship estimation model may be trained by using learning data including input data including parameter values acquired for pairs of households and ground truth data indicating the type of the relation that is the ground truth.

The household relationship estimation module 38 may estimate the relationship between households based on the type of the relation for a pair of users identified by the user relationship identification module 30. For example, when it has been identified by the user relationship identification module 30 that the first user included in the first household and the second user included in the second household have a parent-child relationship, the household relationship estimation module 38 may estimate a parent-child relationship as the type of the relation between the households.

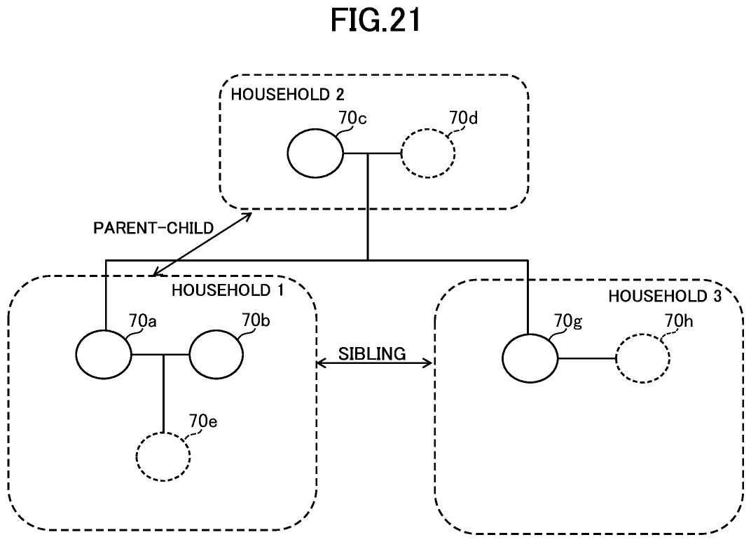

With the processing described so far, it is possible to grasp relationships between households. FIG. 21 is a diagram for illustrating an example of relationships between households. In the example of FIG. 21, a household 2 includes a user 70c and a related user 70f, and a household 3 includes a user 70g and a related user 70h.

In the example of FIG. 21, parent-child is estimated as the type of the relation between the household 2 and the household 1, and sibling is estimated as the type of the relation between the household 1 and the household 3. This relationship corresponds to a case in which the type of the relation between the user 70c belonging to the household 2 and the user 70a belonging to the household 1 is parent-child. Meanwhile, depending on the processing method, it is possible for the household relationship estimation module 38 to estimate the type of the relation between households in consideration of, for example, the sending of gifts between the users 70b and 70c who do not have a direct parent-child relationship.

The usage histories of the various computer systems in this embodiment may be, for example, a history relating to purchases and browsing performed by the target user in the electronic commerce transaction system 42, the type and geographical location of golf courses reserved by the target user in the golf course reservation system 44, the type and geographical location of accommodations or rooms reserved by the target user in the travel reservation system 46, the contract details and purchase history including, for example, a limit amount of the target user in the card management system 50, the geographical location and purchase history of shops, for example, at which payment has been performed by the target user in a payment management system, a history indicating a deposit balance and deposit/withdrawal destination of the target user in an online banking management system, the type of financial products purchased or entered into a contract by the target user in a financial product management system, the type of insurance products purchased or entered into a contract by the target user in an insurance product management system, and a history including location information, call destination, message transmission destination, and the like of the target user that are acquirable in a mobile service management system. The usage history is not limited to any mode as long as the usage history is a history of usage of various computer systems by the target user.

It should be noted that the present invention is not limited to the embodiment described above and various modifications can be made thereto. Further, the recitations of the claims are intended to cover all such modifications as falling within the spirit and scope of the present invention. Further, the specific character strings and numerical values described above and the specific character strings and numerical values in the drawings are merely exemplary, and the present invention is not limited to those character strings and numerical values.

What is claimed is:

1: An information processing system, comprising:
at least one processor; and
at least one memory device that stores a plurality of instructions which, when executed by the at least one processor, causes the at least one processor to:
acquire household information indicating a first household and a second household, each of which includes one or a plurality of users living together; and
estimate a type of a relation between the first household and the second household based on an attribute of a user belonging to the first household and an attribute of a user belonging to the second household.

2: The information processing system according to claim 1,
wherein, in the acquisition of the household information based on a surname and a street address of each of a plurality of users stored in a user database, the first household and the second household each including one or a plurality of users living together from the plurality of users are acquired.

3: The information processing system according to claim 1,
wherein, in the estimation, the type of the relation between the first household and the second household is estimated based on a plurality of parameters relating to a type of a relation between a first user included in the first household and a second user included in the second household.

4: The information processing system according to claim 3, wherein
the plurality of parameters include at least part of whether a surname is the same, a frequency of telephone contact, presence or absence of sending a gift relating to a specific day, a frequency of sending a gift to each other, an age difference, a friend in common, whether gender is the same, and similarity in street addresses.

5: The information processing system according to claim 1, wherein, in the estimation, the type of the relation between the first household and the second household is estimated depending on whether a type of a relation between a first user included in the first household and a second user included in the second household is any of at least part of parent-child, sibling, and neighbor.

6: An information processing method, comprising:
acquiring, with at least one processor operating with a memory device in a system, a first household and a second household each of which includes one or a plurality of users living together; and
estimating, with the at least one processor operating with the memory device in the system, a type of a relation between the first household and the second household based on an attribute of a user belonging to the first household and an attribute of a user belonging to the second household.

7: A non-transitory computer readable storage medium storing a plurality of instructions, wherein when executed by at least one processor, the plurality of instructions cause the at least one processor to:
acquire household information indicating a first household and a second household each of which includes one or a plurality of users living together; and
estimate a type of a relation between the first household and the second household based on an attribute of a user belonging to the first household and an attribute of a user belonging to the second household.
